(19) United States
(12) Patent Application Publication
(10) Pub. No.: US 2023/0313013 A1
(43) Pub. Date: Oct. 5, 2023

(54) HEAT STORAGE MATERIAL AND METHOD FOR PRODUCING HEAT STORAGE MATERIAL

(71) Applicant: HONDA MOTOR CO., LTD., Tokyo (JP)

(72) Inventors: Shoji TAKAHASHI, Saitama (JP); Yushi FUJINAGA, Saitama (JP); Mitsumasa SORAZAWA, Saitama (JP); Takayuki SAKATA, Saitama (JP); Hideki MATSUDA, Saitama (JP)

(21) Appl. No.: 18/190,039

(22) Filed: Mar. 24, 2023

(30) Foreign Application Priority Data
Mar. 30, 2022 (JP) 2022-055424

(51) Int. Cl. C09K 5/06

(52) U.S. Cl. CPC C09K 5/06

(57) ABSTRACT

An object of the present invention is to inhibit the phase separation of a salt hydrate used as a main component of a heat storage material. The inventors have made the present invention based on findings that when added to a heat storage material including a salt hydrate and a supercooling inhibitor, graphene oxide can inhibit the phase separation of the salt hydrate. The present invention is directed to a heat storage material including: a salt hydrate as a main component; a supercooling inhibitor that promotes solidification of the salt hydrate; and graphene oxide. The technical features help to inhibit the phase separation of salt hydrates.

This application is based on and claims the benefit of priority from Japanese Patent Application No. 2022-055424, filed on 30 Mar. 2022, the content of which is incorporated herein by reference.

### BACKGROUND OF THE INVENTION

### Field of the Invention

The present invention relates to a heat storage material that stores latent heat.

### Related Art

In recent years, electric-powered vehicles, such as electric vehicles (EVs) and hybrid electric vehicles (HEVs), have become popular for the purpose of reducing carbon dioxide emissions and thus reducing its adverse impact on the global environment. Electric-powered vehicles are equipped with batteries such as lithium-ion batteries.

Patent Document 1: Japanese Unexamined Patent Application, Publication No. 2004-149796

### SUMMARY OF THE INVENTION

In general, excessively high temperatures cause batteries to discharge and degrade faster. On the other hand, excessively low temperatures cause batteries to lose their ability to output sufficient voltage. This means that it is important to control the temperature of batteries.

The inventors have conceived the idea of using heat storage materials to control the temperature of batteries. Specifically, the inventors have conceived that some heat storage materials can be melted by heat from batteries, for example, at high temperatures so that they will store latent heat and limit the rise in battery temperature by absorbing heat.

A series of materials, such as sodium acetate trihydrate and other salt hydrates, have a high ability to store heat in a low temperature range of 100° C. or below. Unfortunately, salt hydrates are generally known to separate into anhydride and water upon melting. This raises a concern about the possibility that salt hydrates may undergo phase separation into anhydride and water during repeated melting and solidification. A specific concern is that such phase separation may produce a water-rich supernatant, which has lower heat storage density, so that the whole heat storage material system including the supernatant and the residual liquid may also have lower heat storage density.

It is an object of the present invention, which has been made in light of the circumstances mentioned above, to inhibit the phase separation of salt hydrates.

The inventors have completed the present invention based on findings that when added to a heat storage material including a salt hydrate and a supercooling inhibitor, graphene oxide can inhibit the phase separation of the salt hydrate. The present invention is directed to a heat storage material with the technical features according to any one of aspects (1) to (7) below and to a heat storage material production method with the technical features according to aspect (8) below.

(1) A heat storage material including:
a salt hydrate as a main component;
a supercooling inhibitor that promotes solidification of the salt hydrate; and
graphene oxide.

As mentioned above, these technical features help to inhibit the phase separation of salt hydrates.

(2) The heat storage material according to aspect (1), in which the salt hydrate is sodium acetate trihydrate.

A certain heat storage density can be more easily ensured using sodium acetate trihydrate than using other salt hydrates. Thus, this technical feature helps to ensure a relatively high heat storage density.

(3) The heat storage material according to aspect (2), further including potassium nitrate as a melting point adjuster for lowering melting point.

A certain heat storage density can be more easily ensured using a combination of sodium acetate trihydrate and potassium nitrate than using other combinations. Thus, this technical feature helps to ensure a higher heat storage density.

(4) The heat storage material according to any one of aspects (1) to (3), in which the content of the graphene oxide is 0.2% by weight or more.

According to this technical feature, since the content is 0.2% by weight or more the graphene oxide is more reliably effective in inhibiting the phase separation.

(5) The heat storage material according to any one of aspects (1) to (3), in which the content of the graphene oxide is 0.4% by weight or less.

According to this technical feature, since the content is 0.4% by weight or less, the graphene oxide can be easily mixed into the salt hydrate in a sufficiently uniform manner without providing excessively high viscosity to the heat storage material.

(6) The heat storage material according to any one of aspects (1) to (5), in which the supercooling inhibitor is sodium carbonate.

The present inventors have found that if the supercooling inhibitor is sodium carbonate, even when the heat storage material contains graphene oxide, solidification can be promoted during cooling to prevent supercooling. Thus, this technical feature helps to prevent supercooling more reliably.

(7) The heat storage material according to aspect (6), in which the content of the sodium carbonate is 0.5 to 1.0% by weight.

Since the content is 0.5% by weight or more, the sodium carbonate can more reliably promote solidification. Since the content is 1.0% by weight or less, the sodium carbonate is prevented from being so excessive as to make the salt hydrate provide lower heat storage density.

(8) A method for producing a heat storage material including a salt hydrate as a main component, a supercooling inhibitor that promotes solidification of the salt hydrate, and graphene oxide, the method including:
producing a graphene oxide-containing liquid containing water and the graphene oxide; and
adding one selected from the graphene oxide-containing liquid and the salt anhydride which is a salt of the salt hydrate to the other.

If dry graphene oxide is mixed with the salt hydrate, the graphene oxide will be hard to disperse uniformly in the salt hydrate. On the other hand, if the salt hydrate is mixed with the graphene oxide-containing liquid containing water, water is added to the salt hydrate, resulting in excess water. The excessive water may cause the heat storage material to have a lower heat storage density. In this regard, the water content will be less excessive when the anhydrous salt is mixed with the graphene oxide-containing liquid according to the present invention than when the salt hydrate is mixed with the graphene oxide-containing liquid.

The technical features according to aspect (1) help to inhibit the phase separation of the salt hydrate. The technical features according to any one of aspects (2) to (8) provide additional advantageous effects.

### BRIEF DESCRIPTION OF THE DRAWINGS

FIG. 1 is a diagram showing the composition of a heat storage material according to a first embodiment;

FIG. 2 is a flowchart showing a method for producing a heat storage material;

FIG. 3 is a flowchart showing a test procedure;

FIG. 4 is a graph showing the results of DSC of a supernatant liquid;

FIG. 5 is a graph showing the results of DSC of a residual liquid;

FIG. 6 is a graph showing the heat storage density of the supernatant liquid;

FIG. 7 is a graph showing the heat storage density of the residual liquid;

FIG. 8 is a graph showing the results of DSC in a second embodiment; and

FIG. 9 is a graph showing the results of DSC of materials having different graphene oxide contents.

### DETAILED DESCRIPTION OF THE INVENTION

Hereinafter, embodiments of the present invention will be described with reference to the drawings. It will be understood that the embodiments described below are not intended to limit the present invention and may be altered or modified as appropriate for implementation without departing from the gist of the present invention.

### First Embodiment

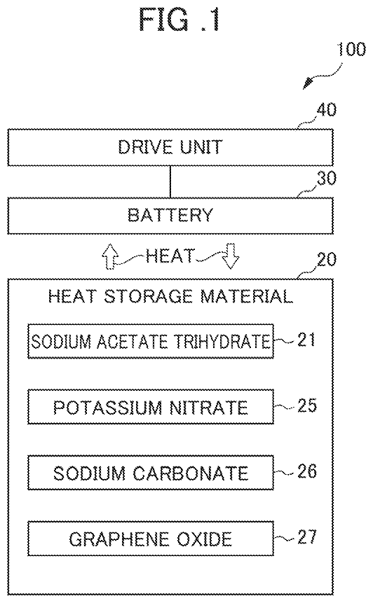

FIG. 1 is a diagram showing the composition of a heat storage material 20 according to the present embodiment. The heat storage material 20 is installed in an electric-powered vehicle 100, such as an EV or HEV. The electric-powered vehicle 100 is equipped with a drive unit 40, such as a motor, that drives the electric-powered vehicle 100 and a battery 30 that supplies power to the drive unit 40. The battery 30 is, for example, a lithium-ion battery with a liquid electrolyte.

The heat storage material 20 is installed for the battery 30 and cools and warms the battery 30 by heat exchange with the battery 30. Thus, the heat storage material 20 serves as both a battery cooler and a battery warmer. The heat storage material 20 includes sodium acetate trihydrate which is a main component 21, potassium nitrate which is a melting point adjuster 25, sodium carbonate which is a supercooling inhibitor 26, and graphene oxide which is a phase separation inhibitor 27.

Sodium acetate trihydrate stores latent heat when it melts and releases latent heat when it solidifies. Potassium nitrate lowers the melting point of sodium acetate trihydrate. Sodium carbonate forms solidification nuclei to promote the solidification of the main component, sodium acetate trihydrate, in the heat storage material 20, so that the heat storage material 20 is prevented from being supercooled in the liquid state, that is, supercooled without releasing latent heat. Graphene oxide inhibits the phase separation of sodium acetate trihydrate into anhydride and water.

The heat storage material 20 includes approximately 20% by weight of potassium nitrate, 0.5 to 1.0% by weight of sodium carbonate, 0.2 to 0.4% by weight of graphene oxide, and the remainder being sodium acetate trihydrate.

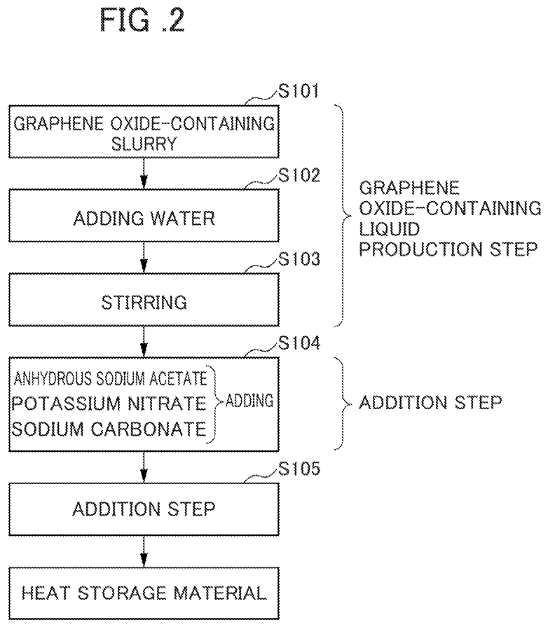

FIG. 2 is a flowchart showing a method for producing the heat storage material 20. First, step S101 of placing a graphene oxide-containing slurry in a 20 mL glass vessel is performed. Next, step S102 of adding water to the slurry is performed. Then, Step S103 of placing a stirrer chip in the glass vessel and stirring the graphene oxide until uniform is performed. The resulting product is a graphene oxide-containing liquid, which contains the graphene oxide and water. Steps S101 to S103 correspond to the step of producing a graphene oxide-containing liquid.

Next, step S104 of adding anhydrous sodium acetate, potassium nitrate, and sodium carbonate to the graphene oxide-containing liquid in the glass vessel is performed. Then, Step S105 of dissolving the potassium nitrate and the sodium carbonate while holding the glass vessel in a hot bath at 80° C. for 20 minutes is performed. This completes the production of the heat storage material 20.

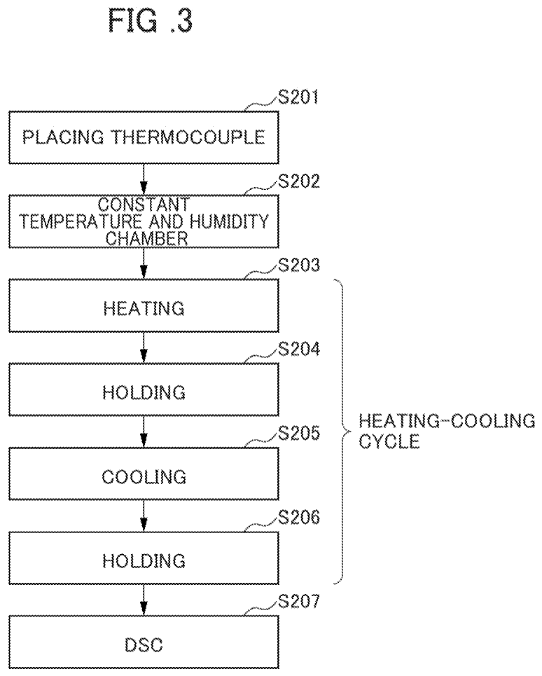

Next, a test for verifying the phase separation-inhibiting effect of graphene oxide will be described with reference to FIGS. 3 to 7. This test was performed a total of four times, twice of which performed in “graphene oxide: 0.2%” in which 0.2% by weight of graphene oxide is contained in the heat storage material, twice of which performed in “graphene oxide: absent” in which no graphene oxide is contained in the heat storage material. Specifically, in this test, for each heat storage material sample, a heating-cooling cycle, which will be described later, was performed, and then DSC, that is, Differential Scanning calorimetry was performed. The details are as follows.

FIG. 3 is a flowchart showing the test procedure. First, step S201 of forming a hole in the cap of the glass vessel containing the heat storage material sample, and inserting a thermocouple into the heat storage material sample through the hole is performed. Next, step S202 of allowing the glass vessel to stand in a constant temperature and humidity chamber is performed.

A heating-cooling cycle including steps S203 to S206 is then started. First, step S203 of heating the heat storage material sample, from a state in which the heat storage material sample is solidified to 55° C. in 20 minutes is performed. This step melts the heat storage material sample. Next, step S204 of holding the heat storage material sample at 55° C. for 160 minutes is performed. Then, Step S205 of cooling the heat storage material sample which is melted to 20° C. in 20 minutes is performed. Then, Step S206 of holding the heat storage material sample at 20° C. for 80 minutes is performed. Thus, the heating-cooling cycle including steps S203 to S206 is completed.

Subsequently, the heat storage material sample is separated into supernatant liquid and residual liquid being other than the supernatant, and DSC is performed. The DSC system used is an input-compensated double furnace DSC 8500 manufactured by PerkinElmer. Under the measurement conditions, the temperature of the heat storage material sample is increased from 10° C. to 60° C. at 5° C. per minute. Helium gas at a flow rate of 20 mL per minute is used as the atmosphere.

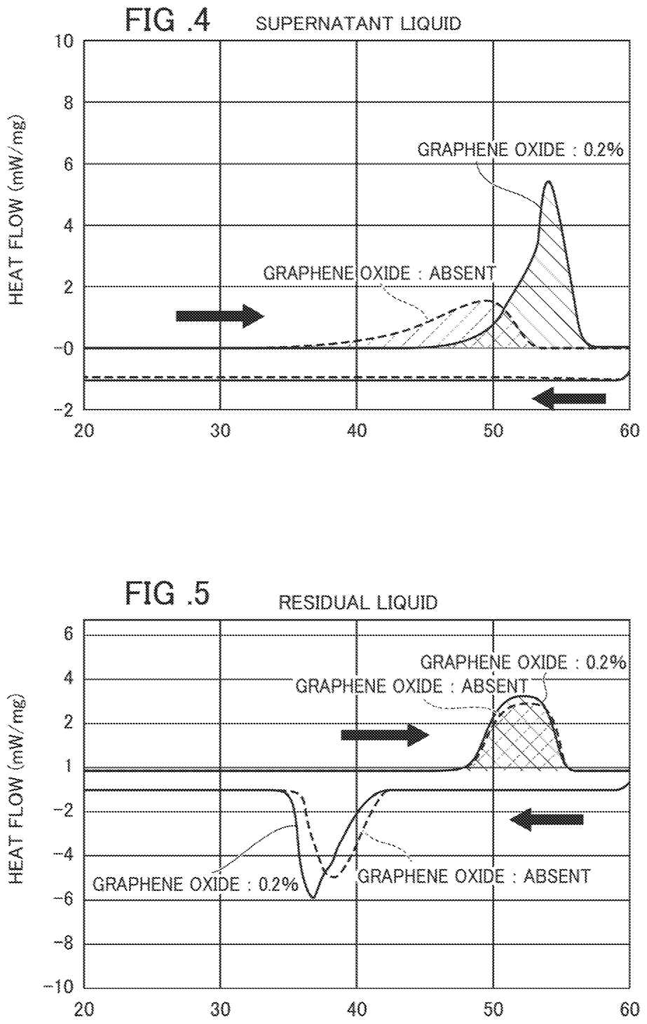

FIGS. 4 and 5 are graphs showing the results of DSC of each of the heat storage material samples. Hereinafter, the “heat flow” will refer to the amount of heat absorbed or released per unit time by a unit weight of the heat storage material during its temperature increase or decrease or phase change. The “heat storage density” will refer to the amount of heat required to melt a unit weight of a material. FIG. 4 is a graph showing the heat flow of the supernatant liquid. FIG. 5 is a graph showing the heat flow of the residual liquid.

These graphs show that in the supernatant liquid shown in FIG. 4, the heat flow projecting upward during melting period where it goes from left to right on the graph is larger in the case of “graphene oxide: 0.2%” than in the case of “graphene oxide: absent”. This indicates that during melting, the heat storage density of the supernatant liquid is higher in the case of “graphene oxide: 0.2%” than in the case of “graphene oxide: absent”.

On the other hand, in the residual liquid shown in FIG. 5, the heat flow projecting upward during melting period where it goes from left to right on the graph hardly differs in the case of “graphene oxide: 0.2%” than in the case of “graphene oxide: absent”. This indicates that during melting, the heat storage density of the residual liquid hardly differs between the case of “graphene oxide: 0.2%” and the case of “graphene oxide: absent”.

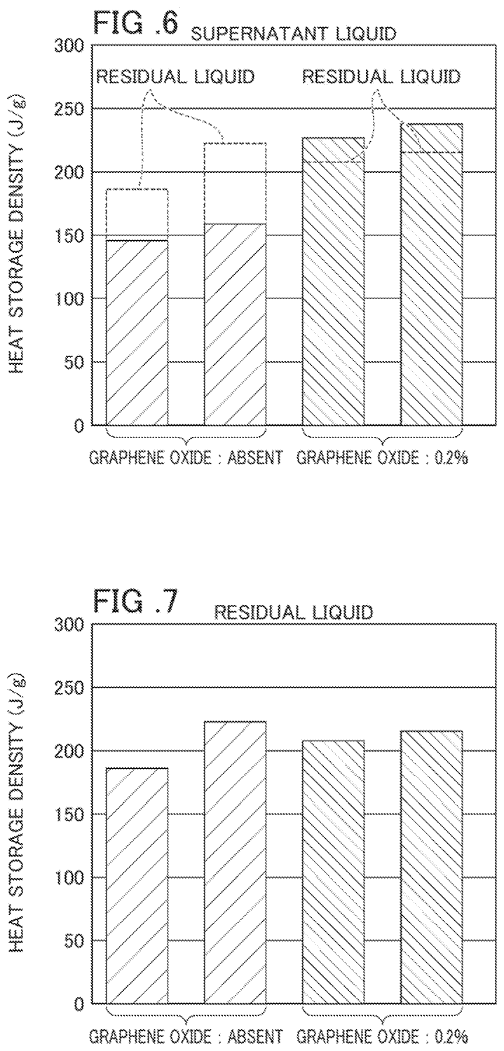

FIGS. 6 and 7 are graphs showing the heat storage density for each of the heat storage material samples. Specifically, FIG. 6 is a graph showing the heat storage density of the supernatant liquid, and FIG. 7 is a graph showing the heat storage density of the residual liquid.

FIGS. 6 and 7 indicate that in the two cases of “graphene oxide: absent” on the left, the heat storage density of the supernatant liquid is significantly lower than that of the residual liquid. This is probably because of the phase separation of sodium acetate trihydrate into anhydride and water, in which water concentrates in the supernatant liquid to cause dilution of the sodium acetate trihydrate.

On the other hand, in the two cases of “graphene oxide: 0.2%” on the right, there is only a small difference between the heat storage density of the supernatant liquid and that of the residual liquid, as compared to the case of “graphene oxide: absent”. This is probably because the graphene oxide inhibits the phase separation of sodium acetate trihydrate. The above demonstrates that the phase separation is less likely to occur in the case of “graphene oxide: 0.2%” than in the case of “graphene oxide: absent”.

Regarding the viscosity of the heat storage material, it was confirmed that at least in a case where the content of graphene oxide is 0.4% by weight, the heat storage material can be sufficiently stirred and graphene oxide can be sufficiently uniformed in sodium acetate trihydrate.

In the present embodiment, therefore, the heat storage material contains 0.2 to 0.4% by weight of graphene oxide.

In the graph of FIG. 5 regarding the residual liquid, during a cooling period in the lower part where it goes from right to left, a section in which the heat flow projects in the negative direction exists in both the case of “graphene oxide: 0.2%” and the case of “graphene oxide: absent”. This section indicates solidification of the heat storage material sample. In contrast, the graph shown in the lower part of FIG. 4 regarding the supernatant liquid has no such negative heat flow peak section during cooling period where it goes from right to left in the graph in the case of “graphene oxide: 0.2%” or the case of “graphene oxide: absent”. This is probably because the supercooling inhibitor, sodium carbonate, goes down to the residual side. It should be noted, however, that before the separation into supernatant liquid and residual liquid, the sodium carbonate existing in the residual liquid can form solidification nuclei to promote the solidification not only in the residual liquid but also in the supernatant liquid.

Hereinafter, advantageous effects of embodiments of the present invention will be summarized.

The addition of graphene oxide to the heat storage material 20 including sodium acetate trihydrate, which is a main component 21, and a supercooling inhibitor 26 has been demonstrated to be effective in inhibiting the phase separation of sodium acetate trihydrate. In this regard, the present embodiment has such a technical feature for the inhibition of the phase separation of sodium acetate trihydrate.

A certain heat storage density can be more easily ensured using a combination of sodium acetate trihydrate and potassium nitrate than using other combinations. In this regard, the present embodiment adopts such a combination to ensure a high heat storage density.

Graphene oxide at a content of 0.2% by weight has been demonstrated to be effective enough to inhibit the phase separation. In this regard, the present embodiment in which the content of graphene oxide is 0.2% by weight or more will produce a sufficient level of phase separation-inhibiting effect.

It has been demonstrated that the heat storage material 20 containing 0.4% by weight of graphene oxide can be sufficiently stirred in such a manner that the graphene oxide is mixed into sodium acetate trihydrate in a sufficiently uniform manner. In this regard, the present embodiment in which the content of graphene oxide is 0.4% by weight or less allows for sufficiently uniform mixing of graphene oxide.

It has been demonstrated that sodium carbonate used as the supercooling inhibitor 26 promotes the solidification of the graphene oxide-containing heat storage material 20 during cooling to prevent the heat storage material 20 from being supercooled in the liquid state. In this regard, the present embodiment using sodium carbonate as the supercooling inhibitor 26 allows for more reliable prevention of the supercooling.

The content of sodium carbonate may be 0.5% by weight or more. This helps to promote the solidification more reliably. The content of sodium carbonate may be 1.0% by weight or less. This helps to prevent sodium carbonate from being so excessive as to make sodium acetate trihydrate provide lower heat storage density.

If dry graphene oxide is mixed with sodium acetate trihydrate, the graphene oxide will be hard to diffuse uniformly in the sodium acetate trihydrate. On the other hand, if the sodium acetate trihydrate is mixed with the graphene oxide-containing liquid containing water, water is added to the sodium acetate trihydrate, resulting in excess water. The excessive water may cause the heat storage material 20 to have a lower heat storage density. In this regard, the water content will be less excessive when step S104 shown in FIG. 2 according to the present embodiment is performed to add anhydrous sodium acetate to the graphene oxide-containing liquid than when sodium acetate trihydrate is added to the graphene oxide-containing liquid.

### Second Embodiment

Next, a second embodiment will be described. The heat storage material 20 of the present embodiment contains disodium hydrogen phosphate dodecahydrate as the main component 21. Except that, the present embodiment is the same as the first embodiment. In this embodiment, graphene oxide helps to inhibit the phase separation of disodium hydrogen phosphate dodecahydrate.

Table 1 below shows the details of heat storage materials 20 with graphene oxide contents of 0% by weight, 0.2% by weight, 0.4% by weight, and 0.7% by weight.

TABLE 1

| | Formulation (Wt. %) | | | | | |
|---|---|---|---|---|---|---|
| | Disodium | Anhydrous | | | DSC measurement results | |
| | hydrogen | disodium | | | Amount | |
| | phosphate | hydrogen | | GO | of heat | Main peak |
| | dodecahydrate | phosphate | Water | slurry | (J/g) | temperature |
| Disodium | 100 | — | — | — | 244.7 | 37.1 |
| hydrogen | | | | | | |
| phosphate | | | | | | |
| dodecahydrate | | | | | | |
| GO-0.2 | — | 39.7% | 44.9% | 15.4% | 244.0 | 37.3 |
| GO-0.4 | — | 39.7% | 29.5% | 30.8% | 234.5 | 39.2 |
| GO-0.7 | — | 39.8% | 6.2% | 54.0% | 191.4 | 52.4 |

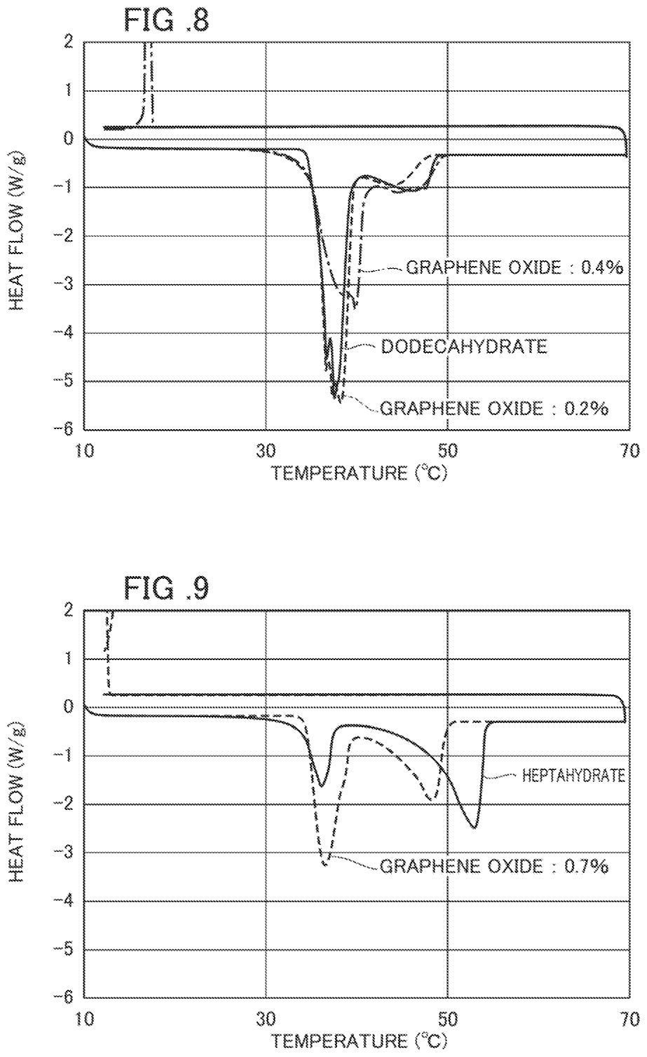

FIG. 8 is a graph showing the results of DSC of the heat storage materials with graphene oxide contents of 0.2% by weight and 0.4% by weight. The graph also shows the results of DSC in the case where the content of graphene oxide is 0%, that is, the results of DSC of disodium hydrogen phosphate dodecahydrate. This graph indicates that compared to the curve of the heat storage material with a graphene oxide content of 0.2% by weight, the curve of the heat storage material with a graphene oxide content of 0.4% by weight more deviates from the curve of disodium hydrogen phosphate dodecahydrate.

FIG. 9 is a graph showing the results of DSC of the heat storage material with a graphene oxide content of 0.7% by weight. This graph also shows the results of DSC of disodium hydrogen phosphate heptahydrate. The graph indicates that the curve of the heat storage material with a graphene oxide content of 0.7% by weight resembles the curve of disodium hydrogen phosphate heptahydrate.

Those results indicate that as the amount of graphene oxide added to the heat storage material including disodium hydrogen phosphate dodecahydrate as a main component increases excessively, the heat flow curve of the resulting heat storage material becomes similar to that of disodium hydrogen phosphate heptahydrate, which suggests a reduction in heat flow and a reduction in the heat storage density of the heat storage material. This is probably because the hydration number of the disodium hydrogen phosphate hydrate decreases as graphene oxide attracts more water molecules. The above suggests that the suitable content of graphene oxide be 0.2 to 0.4% by weight not only in the first embodiment where the main component is sodium acetate trihydrate but also in the second embodiment where the main component is disodium hydrogen phosphate.

### Modified Embodiments

The embodiments described above may be modified, for example, as follows for implementation. The main component of the heat storage material 20 may be a salt hydrate other than sodium acetate trihydrate or disodium hydrogen phosphate dodecahydrate. The battery 30 and the heat storage material 20 may be installed in moving vehicles other than the electric-powered vehicle 100, such as ships and drones, or installed in stationary applications. The heat storage material 20 may be installed for other applications than the battery 30, such as various circuits with large heat generation.

### EXPLANATION OF REFERENCE NUMERALS

20: Heat storage material
21: Main component
25: Melting point adjuster
26: Supercooling inhibitor
27: Phase separation inhibitor
30: Battery
100: Electric-powered vehicle

What is claimed is:

1. A heat storage material comprising:
a salt hydrate as a main component;
a supercooling inhibitor that promotes solidification of the salt hydrate; and
graphene oxide.

2. The heat storage material according to claim 1, wherein the salt hydrate is sodium acetate trihydrate.

3. The heat storage material according to claim 2, further comprising potassium nitrate as a melting point adjuster for lowering melting point.

4. The heat storage material according to claim 1, wherein the content of the graphene oxide is 0.2% by weight or more.

5. The heat storage material according to claim 1, wherein the content of the graphene oxide is 0.4% by weight or less.

6. The heat storage material according to claim 1, wherein the supercooling inhibitor is sodium carbonate.

7. The heat storage material according to claim 6, wherein the content of the sodium carbonate is 0.5 to 1.0% by weight.

8. A method for producing a heat storage material comprising a salt hydrate as a main component, a supercooling inhibitor that promotes solidification of the salt hydrate, and graphene oxide, the method comprising:
producing a graphene oxide-containing liquid containing water and the graphene oxide; and
adding one selected from the graphene oxide-containing liquid and the salt anhydride which is a salt of the salt hydrate to the other.
